(19) United States
(12) Patent Application Publication
(10) Pub. No.: US 2026/0346209 A1
(43) Pub. Date: Nov. 5, 2026

(54) TEMPERATURE-RESPONSIVE SEPARATION MEMBRANE AND PREPARATION METHOD THEREFOR

(71) Applicant: BEIJING DRAINAGE GROUP CO., LTD, Beijing (CN)

(72) Inventors: Lian Yang, Beijing (CN); Guoliang Liu, Beijing (CN); Haoran Qiu, Beijing (CN); Jiang Chang, Beijing (CN)

(21) Appl. No.: 19/471,751

(22) PCT Filed: Nov. 8, 2024
(86) PCT No.: PCT/CN2024/130933

§ 371 Date: Oct. 2, 2025

(30) Foreign Application Priority Data
Dec. 19, 2023 (CN) 202311753984.6

(51) Int. Cl. B01D 69/02; B01D 67/00; B01D 71/34

(52) U.S. Cl. CPC B01D 69/02; B01D 67/0011; B01D 67/0013; B01D 67/0016; B01D 71/34; B01D 2323/08; B01D 2323/12; B01D 2323/18; B01D 2323/21823; B01D 2325/22

(57) ABSTRACT

A temperature-responsive separation membrane and a preparation method therefor. The temperature-responsive separation membrane comprises the following components in parts by weight: 12-20 parts of a polymer membrane material, 60-85 parts of a polar solvent, 0.5-2 parts of a temperature control reagent, 6-10 parts of a polymer pore-forming agent and 0.5-2 parts of an additive. The preparation process for the membrane is simple, continuous, makes it easy to achieve industrialization, convenient in terms of operation and easy to control, and saves on energy consumption and reduces costs; in addition, the prepared temperature-responsive separation membrane can respond to the temperature of the feed solution.

### FIELD OF TECHNOLOGY

The present disclosure relates to the technical field of processing and preparing of sewage treatment materials, more specifically, relates to a temperature-responsive separation membrane and preparation method therefor.

### BACKGROUND

Polyvinylidene fluoride (PVDF) membranes are widely used in water treatment and bioprocessing systems due to their excellent properties. However, the hydrophobic nature of PVDF membranes makes them prone to fouling by proteins, polysaccharides, and other substances during operation. In recent years, stimuli-responsive membranes, such as those responsive to temperature, pH, light, and electricity, have attracted the attention of researchers. Among them, thermoresponsive membranes have separation efficiency and filtration performance that are influenced by the temperature of the feed solution.

Common methods for preparing thermoresponsive membranes include two main approaches. One is the blending modification method, which is widely used in industrial manufacturing. The other involves the use of plasma treatment, light-induced grafting, or other methods to synthesize functional thermosensitive materials or to graft thermosensitive materials onto membrane substrates.

Therefore, there is an urgent need to propose a new type of temperature-responsive separation membrane and its preparation method to reduce manufacturing costs and improve hydrophilicity and antifouling performance.

### SUMMARY

The objective of the present disclosure is to address the deficiencies of the prior art by proposing a temperature-responsive separation membrane and its preparation method. The preparation process of the present disclosure is simple, continuous, and easily scalable for industrial production. It is also convenient to operate and control, which helps to save energy and reduce costs. Moreover, the prepared temperature-responsive separation membrane can respond to the temperature of the feed solution.

To achieve the above objective, one aspect of the present disclosure provides a temperature-responsive separation membrane, the temperature-responsive separation membrane comprising the following components in parts by weight: 12-20 parts of polymer membrane material, 60-85 parts of polar solvent, 0.5-2 parts of temperature control agent, 6-10 parts of polymer pore-forming agent and 0.5-2 parts of additive.

According to the present disclosure, preferably, the temperature-responsive separation membrane comprises the following components in parts by weight: 15-20 parts of polymer membrane material, 65-82 parts of polar solvent, 0.5-1.5 parts of temperature control agent, 7-9 parts of polymer pore-forming agent, and 0.5-1.5 parts of additive.

According to the present disclosure, preferably, the polymer membrane material is polyvinylidene fluoride and/or polytetrafluoroethylene.

According to the present disclosure, preferably, the polar solvent is dimethylacetamide and/or N-methylpyrrolidone.

According to the present disclosure, preferably, the temperature control agent is N-isopropylacrylamide.

According to the present disclosure, preferably, the polymer pore-forming agent is polyvinylpyrrolidone with a degree of polymerization of K15-K90; preferably, the polymer pore-forming agent is polyvinylpyrrolidone PVPK-15 and/or polyvinylpyrrolidone PVPK-30.

According to the present disclosure, preferably, the additive is glycerol and/or cellulose acetate.

The other aspect of the present disclosure provides a method for preparing the temperature-responsive separation membrane, the preparing method comprising the following steps:
step 1: mixing and stirring the polar solvent, temperature control agent, and polymer pore-forming agent evenly to obtain a mixture;
step 2: drying the polymer membrane material to a constant weight to obtain dry powder of the polymer membrane material, mixing and stirring the powder with the mixture and the additive evenly to obtain a casting solution, and then sealing the casting solution for static degassing;
step 3: coating the degassed casting solution onto a nonwoven fabric, after a first preset time, immersing the coated nonwoven fabric into a water coagulation bath for solidification to obtain a solidified membrane; after removing residual solvent from a surface of the solidified membrane, immersing the solidified membrane into a water coagulation bath for a second preset time, removing it from the bath and air-drying it to obtain the temperature-responsive separation membrane.

According to the present disclosure, preferably, in step 1, time for stirring is 7-10 hours, and a speed for stirring is 100 rpm-150 rpm.

According to the present disclosure, preferably, in in step 2, a speed for stirring is 150 rpm-250 rpm.

According to the present disclosure, preferably, the step 2 is carried out at 15-30 °C.

According to the present disclosure, preferably, in step 3:
a thickness of a knife used for coating is 100-2000 μm;
the first preset time is 15-45 seconds;
the residual solvent on the surface of the solidified membrane is removed by washing with water;
the second preset time is 24-48 hours.

According to the present disclosure, preferably, step 3 is carried out at 15-30 °C.

The beneficial effects of the technical solution of the present disclosure are as follows.

The present invention employs a method of blending modification and utilizes the solution phase inversion process, using a polymer membrane material as the matrix and preferably using N-isopropylacrylamide as the temperature control agent. Under the conditions of a polar solvent, the temperature-responsive separation membrane is prepared.

The preparation process of the present invention is simple, continuous, and easily scalable for industrial production. It is also convenient to operate and control, which helps to save energy and reduce costs. Moreover, the temperature-responsive separation membrane prepared can respond to the temperature of the feed solution.

The temperature-responsive separation membrane of the present disclosure can be applied in membrane bioreactors.

Other features and advantages of the present disclosure will be described in detail in the following specific embodiments.

### BRIEF DESCRIPTION OF THE DRAWINGS

The above and other objects, features and advantages of the present disclosure will become more apparent by describing the exemplary embodiments of the present disclosure in more detail with reference to the accompanying drawings, in which the same reference numeral generally refers to the same component in the exemplary embodiments of the present disclosure.

FIG. 1 shows the surface morphology SEM (Scanning Electron Microscopy) image of a temperature-responsive separation membrane provided in Embodiment 1 of the present disclosure.

### DESCRIPTION OF THE EMBODIMENTS

Preferred embodiments of the disclosure will be described in more detail below. Although preferred embodiments of the present disclosure are described below, it should be understood that the present invention may be implemented in various forms and should not be limited to the embodiments set forth herein. Rather, these embodiments are provided so that this disclosure will be thorough and complete, and will fully convey the scope of the invention to those skilled in the art.

### Embodiment 1

The embodiment provides a temperature-responsive separation membrane, the temperature-responsive separation membrane comprising the following components in parts by weight: 18 parts of polyvinylidene fluoride, 70 parts of dimethylacetamide, 1 part of N-isopropylacrylamide, 8 parts of polyvinylpyrrolidone PVPK-15, and 1.5 parts of glycerol.

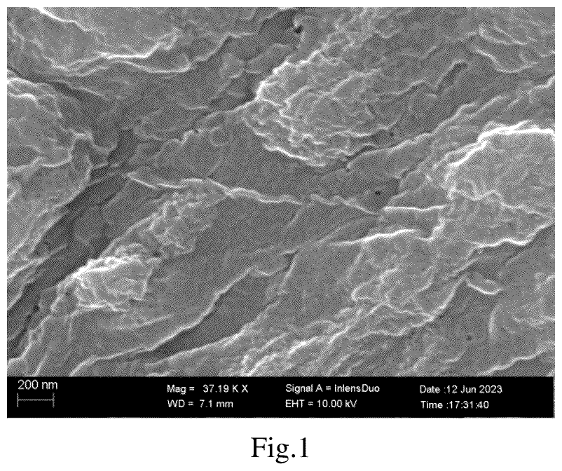

The method for preparing the temperature-responsive separation membrane comprising the following steps:
step 1: mixing and stirring the dimethylacetamide, N-isopropylacrylamide, and polyvinylpyrrolidone PVPK-15 at 150 rpm for 8 hours to obtain a mixture.
step 2: drying the polyvinylidene fluoride to a constant weight to remove moisture and obtain dry powder of polyvinylidene fluoride, mixing and stirring the dry powder with the mixture and glycerol at room temperature and 150 rpm evenly until the polyvinylidene fluoride powder is fully dissolved to obtain a casting solution, then sealing the casting solution for static degassing at room temperature;
step 3: coating (the thickness of the knife used for coating is 150 μm) the degassed casting solution onto a nonwoven fabric, after 15-45 seconds, immersing the nonwoven fabric coated with the casting solution into a water coagulation bath for solidification to obtain a solidified membrane; after removing residual solvent from a surface of the solidified membrane, immersing the solidified membrane into a water coagulation bath for 36 hours, removing it from the bath and air-drying it at room temperature to obtain the temperature-responsive separation membrane, the surface microstructure of the temperature-responsive separation membrane is shown in FIG. 1.

### TESTING EXAMPLE

The temperature-responsive separation membrane of Embodiment 1 was tested for pure water flux performance at different temperatures, and the results are shown in Table 1.

TABLE 1

| | pure water | pure water |
|---|---|---|
| | flux at 25 °C | flux at 35 °C |
| | (LMH) | (LMH) |
| Embodiment 1 | 24.36 (±0.59) | 37.84 (±1.18) |

The above has described various embodiments of the present invention, which are exemplary, not exhaustive, and not limited to the disclosed embodiments. Without deviating from the scope and spirit of the various embodiments described, many modifications and changes are obvious to those skilled in the art.

1. A temperature-responsive separation membrane, comprising the following components in parts by weight: 12-20 parts of polymer membrane material, 60-85 parts of polar solvent, 0.5-2 parts of temperature control agent, 6-10 parts of polymer pore-forming agent and 0.5-2 parts of additive.

2. The temperature-responsive separation membrane according to claim 1, wherein the temperature-responsive separation membrane comprises the following components in parts by weight: 15-20 parts of polymer membrane material, 65-82 parts of polar solvent, 0.5-1.5 parts of temperature control agent, 7-9 parts of polymer pore-forming agent, and 0.5-1.5 parts of additive.

3. The temperature-responsive separation membrane according to claim 1, wherein the polymer membrane material is polyvinylidene fluoride and/or polytetrafluoroethylene;
the polar solvent is dimethylacetamide and/or N-methylpyrrolidone;
the temperature control agent is N-isopropylacrylamide;
the polymer pore-forming agent is polyvinylpyrrolidone with a degree of polymerization of K15-K90;
the additive is glycerol and/or cellulose acetate.

4. The temperature-responsive separation membrane according to claim 3, wherein the polymer pore-forming agent is polyvinylpyrrolidone PVPK-15 and/or polyvinylpyrrolidone PVPK-30.

5. A method for preparing the temperature-responsive separation membrane according to claim 1, the method comprising the following steps:
step 1: mixing and stirring the polar solvent, temperature control agent, and polymer pore-forming agent evenly to obtain a mixture;
step 2: drying the polymer membrane material to a constant weight to obtain dry powder of the polymer membrane material, mixing and stirring the powder with the mixture and the additive evenly to obtain a casting solution, and then sealing the casting solution for static degassing;
step 3: coating the degassed casting solution onto a nonwoven fabric, after a first preset time, immersing the coated nonwoven fabric into a water coagulation bath for solidification to obtain a solidified membrane; after removing residual solvent from a surface of the solidified membrane, immersing the solidified membrane into a water coagulation bath for a second preset time, removing it from the bath and air-drying it to obtain the temperature-responsive separation membrane.

6. The method for preparing the temperature-responsive separation membrane according to claim 5, wherein in step 1, time for stirring is 7-10 hours, and a speed for stirring is 100 rpm-150 rpm.

7. The method for preparing the temperature-responsive separation membrane according to claim 5, wherein in step 2, a speed for stirring is 150 rpm-250 rpm.

8. The method for preparing the temperature-responsive separation membrane according to claim 7, wherein the step 2 is carried out at 15-30 °C.

9. The method for preparing the temperature-responsive separation membrane according to claim 5, wherein in step 3:
a thickness of a knife used for coating is 100-2000 μm;
the first preset time is 15-45 seconds;
the residual solvent on the surface of the solidified membrane is removed by washing with water;
the second preset time is 24-48 hours.

10. The method for preparing the temperature-responsive separation membrane according to claim 9, wherein the step 3 is carried out at 15-30 °C.
